(19) United States
(12) Patent Application Publication
(10) Pub. No.: US 2017/0242685 A1
(43) Pub. Date: Aug. 24, 2017

(54) UPDATING OF FIRMWARE

(71) Applicant: HARTING Electric GmbH & Co. KG, Espelkamp (DE)

(72) Inventors: Klaus Sperlich, Roedinghausen (DE); Dieter Gramsch, Essen (DE); Juri Helbling, Stemwede-Wehdem (DE); Uwe Schroeder, Hannover (DE)

(73) Assignee: Harting Electric GmbH & Co., KG, Espelkamp (DE)

(21) Appl. No.: 15/517,484

(22) PCT Filed: Oct. 21, 2015
(86) PCT No.: PCT/DE2015/100436

§ 371 Date: Apr. 6, 2017

(30) Foreign Application Priority Data
Nov. 10, 2014 (DE) 10 2014 116 321.4

(51) Int. Cl. G06F 9/445

(52) U.S. Cl. CPC G06F 8/665

(57) ABSTRACT

The present disclosure provides a first method for updating firmware of a computer system, which is embedded in a technical device, wherein the technical device has a volatile memory module, wherein the technical device has a non-volatile memory module, in which a firmware update package is stored, wherein the firmware update package contains individual files and associated first checksums, wherein the method runs through the following steps in the specified sequence: a restart (G), a subsequent booting of the computer system (H), and checking if an indicator file exists in the non-volatile memory module (I). Also provided is a second method for updating firmware of the computer system, which is embedded in a technical device, wherein the method runs through the following steps in the specified sequence: a restart (G), a subsequent booting of the computer system (H), and a check as to whether an indicator file exists in the non-volatile memory module (I).

The present invention is directed to a method for preparing an update of firmware of a computer system according to the preamble of independent claim 1, and a method for updating firmware of a computer system according to the preamble of independent claim 2. The present invention also relates to a computer system including a data memory in which a firmware update package is stored according to claim 9.

Such computer systems are also referred to as “embedded devices”. The computer systems are operated via so-called firmware, which includes all necessary control and functional data and control and functional specifications (processes) for the technical device to be operated.

### PRIOR ART

WO 2007 005 790 A2 describes a method for updating firmware of a technical device. Before the update, a local copy of the firmware data package is stored on the storage medium of the technical device. In the case of possible failure of the update, the update may be performed again with the aid of the copy.

However, it may occur that updates are performed using damaged or incomplete files, without an operating error of the device being immediately apparent. The update method of WO 2007 005 790 A2 is not able to protect against such an error.

### TECHNICAL OBJECTIVE

The object of the present invention is to provide for reliable updating of firmware.

This object is achieved via the characteristic features of independent claim 1.

Advantageous embodiments of the present invention are specified in the subclaims.

The core of the present invention lies in a two-stage approach for an update method of firmware. The actual update method is provided in an upstream method.

The methods provided here are particularly advantageously used in so-called switches. Switches are known from network technology.

Firmware is understood by those skilled in the art to be software which is embedded into electronic devices. It is generally stored in flash memory. The firmware is functionally fixedly connected to the hardware, which means that one is not usable without the other. It occupies an intermediate position between hardware (i.e., the physical components of a device) and the application software (the optionally replaceable programs of a device).

A firmware update package is, for example, an unpackable ZIP file, which is generally provided by a manufacturer of the associated technical device. The firmware update package provided here includes files, logs, and scripts, and associated checksums which were generated with the aid of the known md5 algorithm.

After it has been unpacked, the firmware update package relevant to the invention is advantageously made up of three smaller packages. A first package includes all files relevant to the firmware. A second package is made up of at least one so-called script file. Individual commands are read out of the script file and executed. Inter alfa, the script file ensures that the files of the first package are copied to the provided destination folder. A third package is made up of at least one checksum which is associated with a file of the first package, and with the aid of which the correctness of this file may be checked.

If the second package includes only one script file, which is the normal case, the firmware update package is made up of two packages and this script file.

The methods described below are largely directed by the script file.

The provided method is used for preparing an update of firmware of a computer system which is embedded in a technical device. The technical device is equipped with a volatile memory module, for example, RAM memory, and a nonvolatile memory module, for example, flash memory. The method iterates the following method steps in the specified sequence:
First, a firmware update package is downloaded to the volatile memory module. The firmware update package may, for example, be stored on a USE stick and supplied to the technical device via a USE interface.
Subsequently, the firmware update package is copied to the nonvolatile memory module.
An indicator file is then created in the nonvolatile memory module. The function of the indicator file will be described in greater detail below.
Finally, a request is issued to a user by the technical device, including the content for performing a restart of the technical device.

The downstream method relates to the actual update operation of the firmware. All of the files relevant to the firmware are replaced.

The downstream method for updating firmware of a computer system which is embedded in a technical device relates to a technical device including a volatile memory module, for example, RAM memory, and a nonvolatile memory module, for example, flash memory, wherein a firmware update package is stored in the nonvolatile memory module, and wherein the firmware update package includes individual files, logs, and scripts, and associated first checksums.

The downstream method iterates the following method steps in the specified sequence:
First, a restart of the technical device is performed.
Subsequently, it is checked whether an indicator file exists in the nonvolatile memory module.

The indicator file is used as an indicator that the individual files, logs, and scripts of the firmware were downloaded correctly and completely and were copied without error. The function of the indicator file will be highlighted in greater detail below.
If the indicator file does not exist, a startup of firmware of the technical device is performed. The technical device is operated via the available firmware or via the available firmware files. In this case, the downstream update method would be terminated.
However, if the indicator file exists, the firmware update package is copied from the nonvolatile memory module to the volatile memory module. The indicator file indicates here that a firmware update package was downloaded and that an update may be performed.
Subsequently, all files included in the firmware update package are unpacked in the volatile memory module, and the associated second checksums of these files are formed.
The second checksums of the files of the copied firmware update package and the first checksums of the original firmware update package are then compared.
If the first and second checksums of the files are not identical, the firmware update package in the nonvolatile memory module is deleted. The indicator file in the nonvolatile memory module is then also deleted. It is thus ensured that the startup of the technical device does not take place using faulty or damaged firmware. The startup then takes place using a previous version, i.e., using the old firmware.
However, if the checksums of the files of the firmware update package and the copied firmware update package are identical, all files of the firmware update package stored in the volatile memory module are copied to the nonvolatile memory module. In this step, the old firmware files, the old logs, and the old scripts are replaced by new ones.
Subsequently, it is checked whether the copy operation was successful. This generally takes place by reading out internal error logs.
If the copy operation was unsuccessful, the method for updating the firmware is terminated. The indicator file and the firmware update package are retained. After the next restart, the update operation is repeated. Alternatively, a counter may also be integrated here, which terminates the method after n copy attempts, by deleting the indicator file and the firmware update package.
If, however, the copy operation was successful, the firmware update package in the nonvolatile memory module is deleted, since it is no longer needed. This is also advantageous for reasons of memory space. In addition, the indicator file in the nonvolatile memory module is deleted.
Thereafter, a startup of the technical device takes place using the firmware files, logs, and scripts.

An essential element of the present invention is a script file which is included in the firmware update package. This script file is also referred to below as an installation script. The execution of the firmware update is transferred from the computer system to the installation script. The installation script subsequently executes the following method steps:
Copying the firmware update package from the RAM memory module to the flash memory module.
Second checksums of the first package of the firmware update package are now calculated and compared to the first checksums already included.
If the first and second checksums are identical, this indicates error-free firmware files.
The installation script now copies the firmware files to the RAM memory module and installs them.
In order not to stress the flash memory due to unnecessary write accesses, the firmware files are copied only if the previously calculated checksums of the firmware file already installed are not identical to the calculated checksum of the firmware file to be installed.

An essential inventive idea of the described update method is that not only the firmware files to be installed, but also the installation script, are downloaded to the computer system. As a result, a high degree of assurance is achieved that the technical device will not fail due to a damaged firmware update package.

### EXEMPLARY EMBODIMENT

An exemplary embodiment of the present invention is depicted in the drawings and is described in greater detail below. The following are shown:

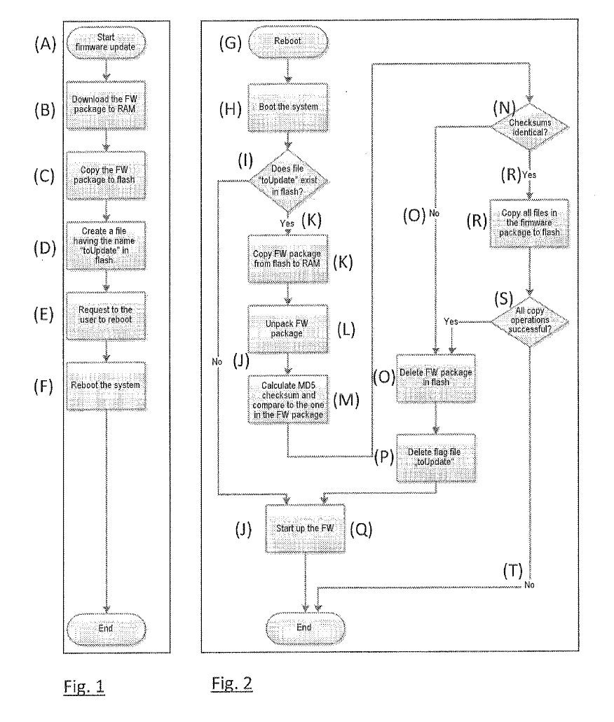

FIG. 1 shows a flow chart of an upstream method for preparing an update, and a flow chart for a downstream method for updating firmware of a technical device;

FIG. 2 shows a flow chart of a downstream method for updating the firmware of the technical device.

The figures include partially simplified schematic representations. Identical reference numerals are used in part for similar but possibly non-identical elements. Various views of similar elements may be scaled differently.

The upstream method in FIG. 1 is used for preparing an update of firmware of a computer system which is embedded in a technical device. The technical device is equipped with a volatile memory module, for example, RAM memory, and with a nonvolatile memory module, for example, flash memory. The method iterates the following method steps in the specified sequence:
The start (A) of the firmware update is, for example, initiated via a so-called command, for example, via a console. The firmware monitors, for example, a certain folder, to determine whether a new update is available.
A firmware update package is then downloaded to the volatile memory module (B). The firmware update package may, for example, be stored on a USB stick and supplied to the technical device via a USE interface.
Subsequently, the firmware update package is copied to the nonvolatile memory module (C).
An indicator file is then created in the nonvolatile memory module (D). The function of the indicator file will be described in greater detail below.
Finally, a request is issued to a user by the technical device, including the content for performing a restart of the technical device (E).
Finally, a restart, a so-called reboot, of the computer system takes place (F). The upstream method is thus terminated.

FIG. 2 shows a flow chart of a downstream method for the actual updating of the firmware of the computer system. The method iterates the following method steps in the specified sequence:
First, the technical device is restarted (G). For example, for this purpose, a request for a “restart” may be made to the user beforehand by the computer system.
Then, the computer system is started up (H).
Subsequently, it is checked whether an indicator file exists in the nonvolatile memory module (I).
If the indicator file does not exist, the computer system or the technical device is started with the aid of the firmware or the corresponding files, logs, and scripts. This is also referred to as starting up the firmware (J). In this case, the downstream method would be terminated.
If, however, the indicator file exists, then the firmware update package is copied from the volatile memory module (RAM) to the nonvolatile (flash) memory module (K).
Subsequently, all files included in the firmware update package are unpacked in the volatile memory module (L).
Thereafter, the associated second checksums of the unpacked files are formed, and the first and second checksums of the files of the firmware update package and the copied firmware update package are then compared (M).
Via the comparison of the checksums, it is checked whether the preceding copy operation was successful (N).
If the first checksums of the files of the firmware update package and the second checksums of the copied firmware update package are not identical, the firmware update package in the nonvolatile memory module is deleted (O).
Subsequently, the indicator file in the nonvolatile memory module is also deleted (P).
Thereafter, the startup of the firmware of the technical device is performed (Q). In this case, the downstream method is terminated.
If the checksums of the files of the firmware update package and the copied firmware update package are identical (R),
all files of the firmware update package stored in the volatile memory module are copied to the nonvolatile memory module (R).
Thereafter, it is checked whether the copy operation was successful (S).
If the copy operation was successful (T), the firmware update package in the nonvolatile memory is deleted (O). Here, the method steps in the flow chart come together again.
Subsequently, the indicator file in the nonvolatile memory is deleted (P).
The startup of the firmware of the technical device then takes place. The downstream method is thereby terminated.
If the copy operation of the files was unsuccessful, the user of the technical device is requested to perform a restart of the technical device (T). The method may optionally restart again at method step (G).

1. A method for preparing an update of firmware of a computer system which is embedded in a technical device,
wherein the technical device has a volatile memory module,
wherein the technical device has a nonvolatile memory module, wherein the method iterates the following method steps in the specified sequence:
starting the update of the firmware (A)
downloading a firmware update package to the volatile memory module (B)
copying the firmware update package to the nonvolatile memory module (C)
creating an indicator file in the nonvolatile memory module (D)
issuing a request to a user to perform a restart of the technical device (E)
restarting the computer system (F).

2. A method for updating firmware of a computer system which is embedded in a technical device,
wherein the technical device includes a volatile memory module,
wherein the technical device includes a nonvolatile memory module, on which a firmware update package is stored
wherein the firmware update package includes individual files and associated first checksums, wherein the method iterates the following method steps in the specified sequence:
a restart (G),
a subsequent startup of the computer system (H), and
a check of whether an indicator file exists in the nonvolatile memory module (I).

3. The method for updating firmware of a computer system as claimed in claim 2,
wherein
if the indicator file does not exist, a startup of firmware of the technical device is performed (J).

4. The method for updating firmware of a computer system as claimed in claim 2,
wherein
if the indicator file exists, the firmware update package is copied from the nonvolatile memory module to the volatile memory module (K)
subsequently, all files included in the firmware update package are unpacked in the volatile memory module (L), and the associated second checksums of the files are formed, and the first and second checksums of the files of the firmware update package and the copied firmware update package are then compared (M).

5. The method for updating firmware of a computer system as claimed in claim 2,
wherein
if the checksums of the files of the firmware update package and the copied firmware update package are not identical, the firmware update package in the nonvolatile memory module is deleted (O), and
the indicator file in the nonvolatile memory module is deleted (P)
and subsequently, a startup of firmware of the technical device is performed (J, Q).

6. The method for updating firmware of a computer system as claimed in claim 4,
wherein
if the checksums of the files of the firmware update package and the copied firmware update package are identical, all files of the firmware update package stored in the volatile memory module are copied to the nonvolatile memory module (R), and
subsequently, it is checked whether the copy operation was successful (S).

7. The method for updating firmware of a computer system as claimed in claim 2,
wherein
if the copy operation was successful, the firmware update package in the nonvolatile memory is deleted (O)
subsequently, the indicator file in the nonvolatile memory is deleted (P), and
a startup of firmware of the technical device is then performed (J, Q).

8. The method for updating firmware of a computer system as claimed in claim 6,
wherein
if the copy operation was unsuccessful, the user of the technical device is requested to perform a restart of the technical device (T).

9. A computer system including a data memory in which a firmware update package is stored, which is made up of three individual packages,
wherein a first package includes all files relevant to the firmware,
wherein a second package includes at least one script file, and
wherein a third package includes at least one checksum which is associated with a file of the first package, and with the aid of which the correctness of this file may be checked.

10. The method for preparing an update of a computer system as claimed in claim 1, wherein the volatile memory module is a RAM memory, and the nonvolatile memory is a flash memory.

11. The method for updating firmware of a computer system as claimed in claim 2, wherein the volatile memory module is a RAM memory, and the nonvolatile memory module is a flash memory.
